(19) United States
(12) Patent Application Publication
(10) Pub. No.: US 2019/0392725 A1
(43) Pub. Date: Dec. 26, 2019

(54) SYSTEM AND METHOD FOR VIRTUAL EXPERIENTIAL IMMERSIVE LEARNING PLATFORM

(71) Applicant: TAMM Innovations, Inc., Long Beach, CA (US)

(72) Inventors: Todd A. ZALKINS, Long Beach, CA (US); Michael B. MEEKER, San Juan Capistrano, CA (US); Ayesha MADNI, Pacific Palisades, CA (US); Matthew H. BOOHER, Dana Point, CA (US)

(21) Appl. No.: 16/019,269

(22) Filed: Jun. 26, 2018

(51) Int. Cl. G09B 9/00; G09B 19/00; G09B 5/06; G09B 7/04

(52) U.S. Cl. CPC G09B 9/00; G09B 7/04; G09B 5/06; G09B 19/00

(57) ABSTRACT

Systems and methods are disclosed for providing a processor-based, virtual experiential immersive learning platform where users observe and interact with various substance abuse situations, related statistics, and resulting consequences. The virtual experience-based immersive learning system includes at least one processor-readable medium communicatively coupled to at least one processor and which stores processor-executable instructions that, when executed by the at least one processor, cause the at least one processor to: enable a user to interact with the platform by first observing typical scenarios and responses; enable a user to gradually become more equipped with tools and strategies to experience and respond to typical scenarios on their own; and enable a user to connect with other users and learn from the other users through their shared responses.

### TECHNICAL FIELD

The present disclosure generally relates to systems and methods for a virtual experiential immersive learning platform, and, particularly, to systems and methods for a virtual experiential immersive learning platform to prevent substance abuse.

### BACKGROUND

### Description of the Related Art

The statistics related to the epidemic of substance abuse are overwhelming. Currently, it has been estimated that every day there are approximately 1,000 visits to the emergency rooms of hospitals related to opioid overdoses alone. It is further estimated that these emergency rooms result in 178 deaths per day. Fatal overdoses from opiate medications such as oxycodone, hydrocodone, and methadone have quadrupled since 1999. Individuals who overdose include both one-time users and those with opioid addictions. Significantly, ninety percent of addictions begin in adolescence.

For decades there have been attempts (educational campaigns and the like) to decrease or, ideally, eliminate substance abuse in the general population, and particularly in teenagers and young adults. However, for a large percentage of the population, attempts to curtail substance abuse have been unsuccessful, and substance abuse continues to be on the rise. One significant reason that substance abuse continues to increase in spite of these attempts is that purely educational techniques fail to create the feelings, emotions, temptations, and the like, that are experienced by individuals in the moment when they are trying to make positive decisions to not engage in substance abuse related activities. There is a continuing need in the art for a way to teach individuals to develop the skills to combat substance abuse in comparable situations to the ones that they will encounter in real life.

Notably, all of the subject matter discussed in this section is not necessarily prior art, and should not be assumed to be prior art merely as a result of its discussion in this section. Accordingly, any recognition of problems in the prior art discussed in this section or associated with such subject matter should not be treated as prior art unless expressly stated to be prior art. Instead, the discussion of any subject matter in this section should be treated as part of the identification of the technological problem to be overcome, which in and of itself may also be inventive.

### BRIEF SUMMARY

A system for providing a processor-based, virtual experiential immersive learning platform where a user observes and interacts with various substance abuse scenarios and resulting consequences from user decisions may be summarized as including: at least one processor-based server and at least one processor-based interactive display device in communication with the at least one processor-based server. The at least one processor-based server contains immersive 360-degree video content that includes interactive video hotspots with virtual substance abuse scenarios. The interactive video hotspots enable the user to interact with discrete locations in the virtual substance abuse scenarios to link to additional interactive content. The interactive video hotspots enable the user to proceed through the immersive 360-degree video content in a non-linear self-directed course, and provide responses to decision points in the virtual substance abuse scenarios.

The at least one processor-based interactive display device includes at least one processor and at least one processor-readable medium communicatively coupled to the at least one processor and which stores processor-executable instructions that, when executed by the at least one processor, cause the at least one processor to: enable the user to interact with the processor-based, virtual experiential immersive learning platform in an observational stage within the virtual substance abuse scenarios, wherein the user observes typical scenarios and responses in the observational stage within the virtual substance abuse scenarios; enable the user to interact with the processor-based, virtual experiential immersive learning platform in an experiential stage within the virtual substance abuse scenarios, wherein the user is prompted to interact with the virtual substance abuse scenarios, make choices within the virtual substance abuse scenarios, and provide responses to decision points within the virtual substance abuse scenarios; enable the user to interact with the processor-based, virtual experiential immersive learning platform in an assessment stage within the virtual substance abuse scenarios, wherein the user is prompted to record and upload self-assessment videos critiquing the responses of the user interacting with the virtual substance abuse scenarios in the experiential stage; and enable the user to interact with other users within the processor-based, virtual experiential immersive learning platform within the virtual substance abuse scenarios, and learn from the other users through shared responses from the other users.

In some implementations, the virtual experiential immersive learning platform enables the user to provide adaptive responses to decision points within the virtual substance abuse scenarios. In another aspect of some implementations, the adaptive response includes user actions of think, feel, pause, breathe, say, and do, via the virtual experiential immersive learning platform. In other implementations, the virtual experiential immersive learning platform enables the user to provide non-adaptive responses to decision points within the virtual substance abuse scenarios. In some implementations, when the user provides a non-adaptive response, another character intervenes in the user's non-adaptive response so that the user does not actually engage in the substance abuse (or other undesirable choice) within the virtual scenario.

In one or more implementations, the resulting consequences from user decisions to decision points in the substance abuse scenarios experienced on the virtual experiential immersive learning platform include statistics, short term consequences, and long term consequences. In some implementations, the substance abuse lessons experienced on the virtual experiential immersive learning platform include multiple scenarios per level, wherein the user determines an order in which the multiple scenarios per level are observed and experienced, wherein all of the multiple scenarios per level must be successfully completed before the user may progress to a next level, wherein the substance abuse lessons include multiple levels per lesson, wherein the multiple levels have increasing levels of difficulty, and wherein the multiple levels must be completed in a fixed order from lower difficulty to highest difficulty. In another aspect of some implementations, the user responses to decision points within the virtual substance abuse scenarios on the virtual experiential immersive learning platform include helping other users in the virtual substance abuse scenarios make positive choices and helping virtual characters in the virtual substance abuse scenarios make positive choices.

In some implementations, the virtual experiential immersive learning platform enables the user to be assisted to make positive choices by the other users at decision points within the virtual substance abuse scenarios. In other implementations, the virtual experiential immersive learning platform enables the user to be assisted to make positive choices by the virtual characters at decision points within the virtual substance abuse scenarios. In another aspect of some implementations, a substance abuse lesson provided on the virtual experiential immersive learning platform includes a pre-test scenario before the observational stage and a post-test scenario after the assessment stage. In still another aspect of some implementations, a substance abuse lesson provided on the processor-based, virtual experiential immersive learning platform includes a celebrity introduction stage before the observational stage.

In one or more implementations, a substance abuse lesson provided on the processor-based, virtual experiential immersive learning platform includes team participation of multiple users in at least the experiential phase of the virtual substance abuse scenarios. In another aspect of some implementations, the user within the virtual substance abuse scenarios on the virtual experiential immersive learning platform is assisted to make positive choices at decision points by the virtual characters in some of the virtual substance abuse scenarios, and wherein the user within the virtual substance abuse scenarios on the virtual experiential immersive learning platform is tempted to make negative choices at decision points by the virtual characters in other of the virtual substance abuse scenarios. In still another aspect of some implementations, the user is prompted to select a specific scenario from a collection in an interactive lesson map, the specific scenarios including: a party at friend's house, a home environment, a work environment, a locker room environment, a dating scenario, a night club environment, a supportive friends scenario, and a bad-influence friends scenario.

In some implementations, after the user enters the selected specific scenario, the user is then provided with various decision points from which to select an action from within that selected specific scenario, the various decision points including: follow your friends into the bathroom, sit down on the couch, talk to a virtual character, and go to the bar. In another aspect of some implementations, the experiential phase of the virtual substance abuse scenarios on the virtual experiential immersive learning platform includes prompting the user to provide video response answers to questions that include “what do you do,” “how did you do it,” and “why did you do it.” In still another aspect of some implementations, the user to prompted to submit a creative solution to a make positive choice in a virtual substance abuse scenario, after which the user submits the creative solution to make the positive choice in a virtual substance abuse scenario. The user is then given a choice to opt in and share the creative solution with other users or to opt out and not share the creative solution with other users. In yet another aspect of some implementations, after the user has made a positive choice in a virtual substance abuse scenario, the user is provided with a selection of creative solutions that fit with the current scenario to assist in immersive experiential learning.

In still another implementation, a method for providing a processor-based, virtual experiential immersive learning platform where a user observes and interacts with various substance abuse scenarios and resulting consequences from user decisions may be summarized as including: providing at least one processor-based server containing immersive 360-degree video content that includes interactive video hotspots with virtual substance abuse scenarios; enabling, via the interactive video hotspots, the user to interact with discrete locations in the virtual substance abuse scenarios to link to additional interactive content; enabling, via the interactive video hotspots, the user to proceed through the immersive 360-degree video content in a non-linear self-directed course and provide responses to decision points in the virtual substance abuse scenarios; communicating, via a communication network, between at least one processor-based interactive display device and the at least one processor-based server, the at least one processor-based interactive display device including at least one processor and at least one processor-readable medium communicatively coupled to the at least one processor and which stores processor-executable instructions; enabling the user to interact with the processor-based, virtual experiential immersive learning platform in an observational stage within the virtual substance abuse scenarios, wherein the user observes typical scenarios and responses in the observational stage within the virtual substance abuse scenarios; enabling the user to interact with the processor-based, virtual experiential immersive learning platform in an experiential stage within the virtual substance abuse scenarios, wherein the user is prompted to interact with the virtual substance abuse scenarios, make choices within the virtual substance abuse scenarios, and provide responses to decision points within the virtual substance abuse scenarios; and enabling the user to interact with the processor-based, virtual experiential immersive learning platform in an assessment stage within the virtual substance abuse scenarios, wherein the user is prompted to record and upload self-assessment videos critiquing the responses of the user interacting with the virtual substance abuse scenarios in the experiential stage.

In still another implementation, a system for providing a processor-based, virtual experiential immersive learning platform where a user observes and interacts with various scenarios and resulting consequences from user decisions may be summarized as including: at least one processor-based server and at least one processor-based interactive display device in communication with the at least one processor-based server. The at least one processor-based server contains immersive 360-degree video content that includes interactive video hotspots with virtual scenarios. The interactive video hotspots enable the user to interact with discrete locations in the virtual scenarios to link to additional interactive content. The interactive video hotspots enable the user to proceed through the immersive 360-degree video content in a non-linear self-directed course and provide responses to decision points in the virtual scenarios.

The at least one processor-based interactive display device includes at least one processor and at least one processor-readable medium communicatively coupled to the at least one processor and which stores processor-executable instructions that, when executed by the at least one processor, cause the at least one processor to: enable the user to interact with the processor-based, virtual experiential immersive learning platform in an observational stage within the virtual scenarios, wherein the user observes typical scenarios and responses in the observational stage within the virtual scenarios; and enable the user to interact with the processor-based, virtual experiential immersive learning platform in an experiential stage within the virtual scenarios, wherein the user is prompted to interact with the virtual scenarios, make choices within the virtual scenarios, and provide responses to decision points within the virtual scenarios.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1A is a schematic diagram showing a user interfacing with a system for virtual experiential immersive learning platform, via a smart phone.

FIG. 1B is a diagram of a system for virtual experiential immersive learning platform, presenting a virtual experiential immersive learning scenario on a smart phone display.

FIG. 2 is a logic diagram showing a method of presenting a virtual experiential immersive learning program, in accordance with the disclosed systems and methods.

FIG. 3 is a logic diagram showing one implementation of a lesson advancement configuration with corresponding levels and scenarios, in accordance with the disclosed systems and methods.

FIG. 4 is a diagram showing one implementation of lesson units, lesson objectives, and key learning objectives, in accordance with the virtual experiential immersive learning program.

FIG. 5 is a diagram showing another implementation of lesson units, lesson objectives, and key learning objectives, in accordance with the virtual experiential immersive learning program.

FIG. 6 is a block diagram of an example processor-based device used to implement one or more of the electronic devices described herein, according to one non-limiting illustrated implementation.

### DETAILED DESCRIPTION

Persons of ordinary skill in the art will understand that the present disclosure is illustrative only and not in any way limiting. Other embodiments and various combinations of the presently disclosed system and method readily suggest themselves to such skilled persons having the assistance of this disclosure.

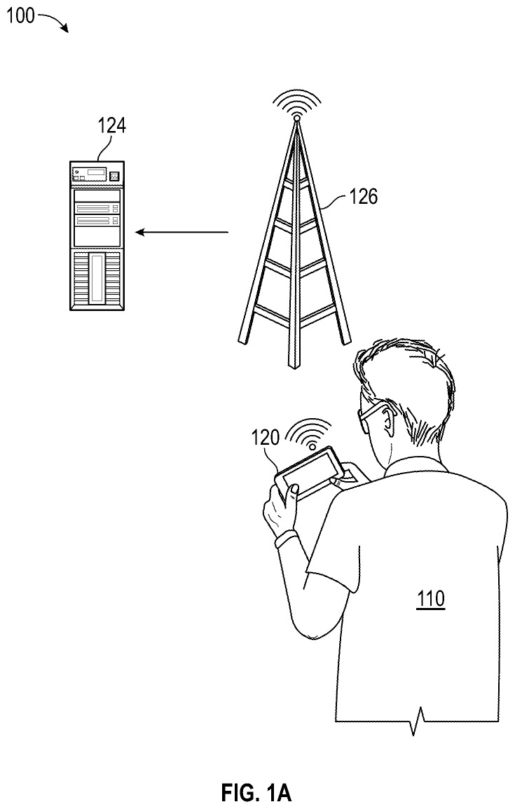

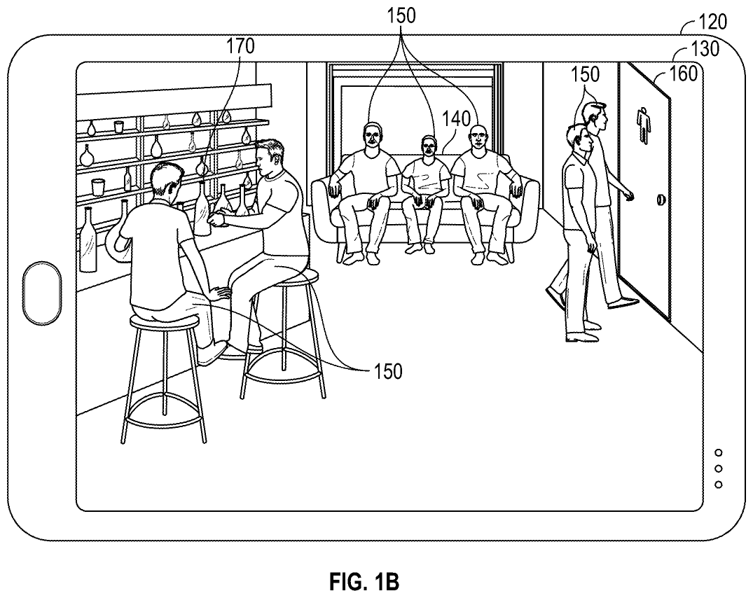

Each of the features and teachings disclosed herein can be utilized separately or in conjunction with other features and teachings to provide a system for virtual experiential immersive learning platform. Representative examples utilizing many of these additional features and teachings, both separately and in combination, are described in further detail with reference to attached FIGS. 1A-6. This detailed description is intended to teach a person of skill in the art further details for practicing aspects of the present teachings, and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm, as described herein, is a sequence of steps leading to a desired result. The steps are those requiring physical manipulations of physical quantities.

Unless specifically stated otherwise as apparent from the below discussion, it is appreciated that throughout the description, discussions utilizing terms such as “processing,” “computing,” “calculating,” “determining,” “displaying,” “configuring,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes. Such a computer program may be stored in a computer readable storage medium, such as, but not limited to, any type of disk, including floppy disks, optical disks, CD ROMs, and magnetic optical disks, read only memories (ROMs), random access memories (RAMs), EPROMs, EEPROMs, magnetic or optical cards, or any type of media suitable for storing electronic instructions, and each coupled to a computer system bus.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Reference throughout this specification to “one implementation” or “an implementation” means that a particular feature, structures, or characteristics may be combined in any suitable manner in one or more implementations. As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise. The headings and Abstract of the Disclosure provided herein are for convenience only and do not interpret the scope or meaning of the implementations.

An embodiment is shown of the system for virtual experiential immersive learning platform. Referring now to the drawings, wherein like reference numerals denote like or corresponding parts throughout the drawings, and more particularly to FIGS. 1A-6, there is shown a system and method for virtual experiential immersive learning platform.

FIGS. 1A-6 present illustrative diagrams of a system and method for virtual experiential immersive learning platform 100. The system for virtual experiential immersive learning platform 100 combines the technology of 360-degree video with an interactive video tool (e.g., interactive video “hotspots”) and create a “choose your own path” style narrative where the user 110 experiences different scenarios through a screen of a processor-based display device 120 (e.g., smart phone). The system for virtual experiential immersive learning platform 100 enables the user 110 to practice the skills, techniques, and tools they have learned, and then assess those skills, techniques, and tools by uploading user-generated videos with a self-critique. The combination of these technologies and original content create a unique virtual experiential learning environment.

By filming in 360-degree video, a user 110 may turn in any direction and see what is in that direction through the screen of a processor-based display device 120. This creates the sensation that the user 110 is immersed within the 360-degree video environment. While 360-degree video is often associated with virtual reality and virtual reality head-sets, 360-degree video may be experienced by a user 110 via a smart phone display screen of other processor-based display device 120.

Regarding interactive video hotspots, video hotspot technology enables a “display only” (one-way) video experience to be transformed into an interactive (two-way) video experience by adding clickable areas within the viewing area. In this manner, interactivity may be added to any video, such as 360-degree video. In some implementations, hotspots may be created by dragging and dropping hotspots into 360-degree video experience, and then linking those hotspots to other video, images, or content. In one or more implementations, these hotspots may be customizable.

Additionally, in some implementations, the system and method for virtual experiential immersive learning platform 100 utilizes a “choose your own path” style of narrative. In application, this means that a user 110 may take different paths to proceed from the beginning to the end of a lesson or virtual simulation. This is unlike any book, movie, or instructional video, in that the user 110 may proceed in a non-linear and user-directed path through the scenarios of the virtual experiential immersive learning platform 100. The combination of these technological improvements creates an immersive learning unlike anything else.

In some implementations, the system for virtual experiential immersive learning platform 100, which is a cross-platform application targeted toward young teens to early adults, may be accessed across devices (i.e., smartphone, tablet, laptop, desktop, and the like). In most implementations of the system for virtual experiential immersive learning platform 100, users 110 will experience the platform on a smartphone. However, in some implementations, virtual reality goggles (or other VR equipment) may be employed. The system for virtual experiential immersive learning platform 100 is suitable for the display of any electronic device with communication functionality (i.e., smart phone). However, the system for virtual experiential immersive learning platform 100 is also well-suited for wearable heads-up displays, smart glasses, see-through displays, and other electronic devices.

The system includes at least one processor and a non-transitory processor-readable medium communicatively coupled to the at least one processor. The processor-readable medium stores processor-executable instructions. As described above, the system includes a processor-based display device 120 that is utilized by a user 110. As shown in FIG. 1A, in one implementation, the processor-based display device 120 is in communication with a processor-based server 124 via a network communication tower 126. In some implementations, the 360-degree video with the embedded interactive video hotspots is stored on the processor-based server 124 and accessed for viewing and interaction via the processor-based display device 120. The mobile processor-based display device 120 may be a smart phone, phablet (not shown), tablet computers (not shown), laptop computers (not shown), smart watches, and the like. In this manner, the system for virtual experiential immersive learning platform 100 may be implemented using any type of communication device and/or internet connected device.

In various implementations of the system for virtual experiential immersive learning platform 100, users 110 observe and interact with various substance abuse situations, related statistics, and resulting consequences. The virtual experiential immersive learning platform 100 (1) enables a user 110 to interact with the platform by first observing typical scenarios and responses, (2) enables a user 110 to gradually become more equipped with tools and strategies to experience and respond to typical scenarios on their own, and (3) enables a user 110 to connect with other users and learn from the other users through their shared responses.

In this manner, the system for virtual experiential immersive learning platform 100 teaches the users 110 to say “No” to substance abuse in actual immersive situations. It is fine to instruct a user 110 that may be susceptible to substantial abuse temptation and/or peer pressure in purely academic environment; however, by using the virtual experiential immersive environment of the system for virtual experiential immersive learning platform 100, a user 110 feels the raw emotions of the temptations, urges, yearning, and pressure to emulate others that occur in the real-world, via a virtual experiential immersion environment.

The system for virtual experiential immersive learning platform 100 is able to teach the users 110 of the platform important skills including by way of example only, and not by way of limitation, self-efficacy, growth mindset, self-worth, self-awareness, assertiveness/resilience, responsible decision-making, creative problem-solving, situational awareness, and addiction vulnerability. Self-efficacy is the belief in your ability to succeed in specific situations or accomplish a task. Growth mindset is the understanding that abilities and intelligence can be developed. Self-worth is the sense of your own value or worth as a person (a general self-appraisal). Self-awareness is the ability to accurately perceive your emotions and stay aware of them as they happen. Assertiveness is the asking for what you want and standing up for yourself or others without aggression or by resorting to passivity. Responsible decision-making is the ability to make constructive choices about personal behavior and social interactions based on ethical standards, safety concerns, and social norms. Creative problem-solving is approaching a problem or challenge in an imaginative and innovative way. Situational awareness is being aware of what is happening around you including where you are, where you are supposed to be, and whether anyone or anything around you is a threat to your health and safety. Addiction vulnerability is the genetic, physiological, psychological, and social predispositions to engage in addictive behaviors.

Referring now to FIG. 1B, a display screen 130 of a processor-based display device 120 is shown as it would be seen by a user 110 of the system and method for virtual experiential immersive learning platform 100. The display screen 130 presents the scenario of a friend's house party. Inside the friend's house, a living room may be seen with a couch 140 with party attendees (virtual characters 150) seated on the couch. A door to a bathroom 160 also may be seen with two people (virtual characters 150) waiting to use the bath room. Additionally, a group of people (virtual characters 150) may be seen standing around a bar set-up 170. In this implementation and scenario, interactive video hotspots are embedded near at least the couch 140, the bathroom 160, and the bar set-up 170. This presents the user 110 with different user-selected options for proceeding through the scenario. In some implementations of this scenario on the virtual experiential immersive learning platform 100, there may be between five and ten interactive video hotspots. In other implementations of this scenario on the virtual experiential immersive learning platform 100, there may be a larger or smaller number of interactive video hotspots.

In some implementations of the system and method for virtual experiential immersive learning platform 100, the system presents the user 110 with substance abuse situations configured for adaptive responses, via the interactive video hotspots, using rational emotive behavior therapy. The virtual experiential immersive learning platform 100 presented to the user 110 by the system enables the user 110 to identify, observe, and experience the thoughts and feelings that may result in an adaptive (as opposed to a non-adaptive) response to substance abuse situations. In this manner, the system and method for virtual experiential immersive learning platform 100 enables the user 110 to become more self-aware in such situations, which results in more adaptive thoughts and feelings, and thereby an adaptive response. In one or more implementations of the system and method for virtual experiential immersive learning platform 100, the adaptive response elicited from the user 110 includes both making responsible decisions and solving problems creatively.

In at least one implementation, the system and method for the virtual experiential immersive learning platform 100 uses an instructional sequence that includes an adaptive response based in social cognitive theory. The user 110 navigates the instructional sequence using the interactive video hotspots. The instructional sequence then progresses from observational learning to enactive learning. In some implementations, the instructional sequence includes several examples and non-examples of the adaptive response. In some implementations, the non-examples of the adaptive response include inappropriate (e.g., negative) responses, choice, or actions (e.g., a decision to engage in substance abuse). In one or more non-limiting examples, the adaptive response consists of the following steps: Think, Feel, Pause, Breathe, Say, and Do (TFPBSD). In this manner, the system and method for the virtual experiential immersive learning platform 100 enables users 110 to develop confidence and participate in experiential immersive learning. Notably, the system and method for the virtual experiential immersive learning platform 100 enables users 110 to observe and partake in virtual interactions, and practice creative solutions across occasions and contexts. This type of observational and experiential immersive learning is a significant advancement that is achieved by using the system and method for the virtual experiential immersive learning platform 100.

In some implementations, the system and method for the virtual experiential immersive learning platform 100 includes additional experiential immersive learning features. One such additional experiential immersive learning feature is the hidden celebrity feature. The inclusion of a hidden celebrity in an experiential immersive learning environment causes the user 110 to experience higher levels of emotion response, and may present addition levels of skills to be required for the user 110 to successfully navigate this feature. In one or more implementations, each user 110 lesson presented by the system and method for the virtual experiential immersive learning platform 100 has a celebrity cameo hidden somewhere among the scenarios. In one such implementation, the user 110 is introduced to the celebrity before the lesson and encouraged to find them in the scenarios. In still another aspect of the hidden celebrity feature, the celebrity scenario may lead to special perks like concert passes or song downloads.

Another such additional experiential immersive learning feature of the system and method for the virtual experiential immersive learning platform 100 is a team mode. In one or more implementations, after the users 110 of the virtual experiential immersive learning platform 100 have had ample exposure to the content of a particular lesson, the users 110 have the opportunity to form a team to complete one or more levels. In this manner, the system and method for the virtual experiential immersive learning platform 100 mirrors real-life scenarios of experiencing temptations in a group and reinforces the mechanisms of intervening on a friend's behalf or being tempted by a friend's behavior.

Still another such additional experiential immersive learning feature of the system and method for the virtual experiential immersive learning platform 100 is an episodic and user-dictated story line. In one or more implementations of the virtual experiential immersive learning platform 100, each lesson and level includes an episodic and user-dictated story line that continues the learning experience progresses. During the learning process within the virtual experiential immersive learning platform 100, the user 110 becomes more familiar with the virtual characters 150 and establishes a degree of trust and relationship with them. This development of trust and relationship with virtual characters 150 in the virtual experiential immersive learning environment creates a realistic dynamic that is often involved in “real-world” substance abuse situations and temptations. In various implementations, virtual characters 150 that at one time were allies and supporters of the user 110 may become tempters or require intervention by the user 110 later in the lessons.

In another aspect, the system and method for the virtual experiential immersive learning platform 100 is configured with developmentally (e.g., age) appropriate content. For example, in some implementations, the lesson content in the virtual experiential immersive learning environment is developed to be age-appropriate for middle school (ages 10-13 years) and high school (ages 14-18 years) users 110. In other implementations, the lesson content in the virtual experiential immersive learning environment is developed to be age-appropriate for adult (21-55) users 110. In this manner, a version of the content is developed for each respective age-group for varying implementations. Accordingly, each version of the developmentally appropriate content is informed by exploratory research and focus groups to determine accurate, real-life situations for each group.

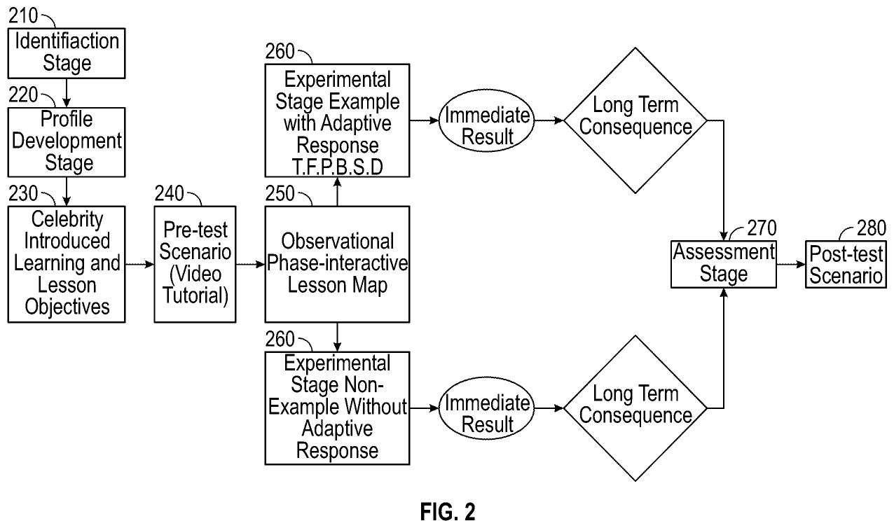

Referring now to FIG. 2, the episodic and user-dictated lesson flow of the system and method for the virtual experiential immersive learning platform 100 proceeds as described below. In some implementations, a user 110 first logs in to the system and accepts the terms of service in an identification stage 210. In another aspect of some implementations, after logging in to the system and accepting the terms of service, the user 110 is provided with questions targeting their passions, purpose, and goals for the future. In still another aspect, the user 110 is also asked to answer questions related to their self-efficacy, self-worth, and growth mindset, as well as create an avatar. These types of questions are part of a profile development stage 220 of the virtual experiential immersive learning platform 100.

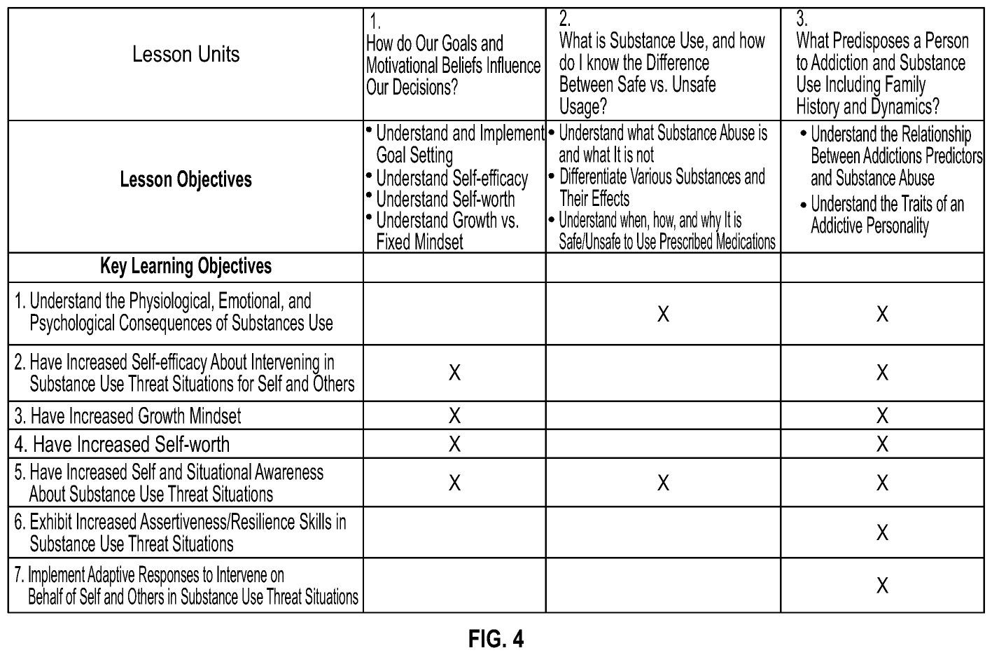

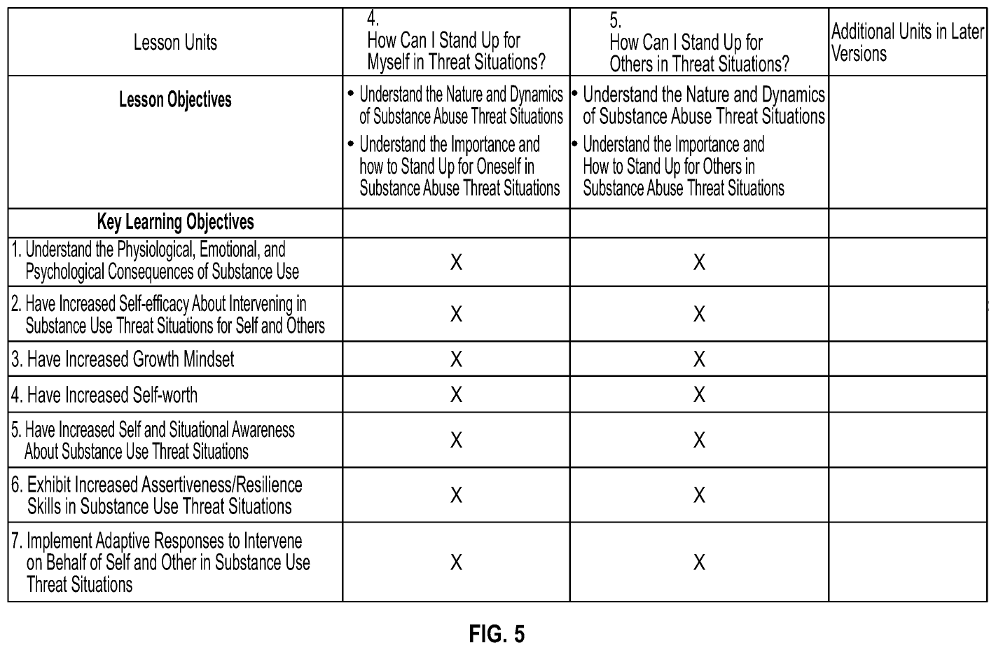

After a user 110 completes these questions in the profile development stage 220 of the virtual experiential immersive learning platform 100, the user 110 proceeds to an introductory scenario provided by a celebrity in an introduction stage 230. In some implementations, as part of the introduction stage 230 of virtual experiential immersive learning platform 100, a celebrity presents the lesson and learning objectives (See FIGS. 4-5) targeted in the respective lesson to the user 110, and guides the user 110 into an initial scenario. In one or more embodiments, this initial scenario is referred to as the pre-test scenario stage 240 of the virtual experiential immersive learning platform 100.

After the user 110 completes the pre-test scenario stage 240 of the virtual experiential immersive learning platform 100, the user 110 is prompted to select a specific context (e.g., party at friend's house, home environment, work environment, locker room environment, dating scenario, night club environment, supportive friends environment, “bad influence” friends environment, and the like) from a collection in an interactive lesson map. This user-directed phase of the virtual experiential immersive learning platform 100 is the observational stage 250. When the user 110 selects the context of interest, the user 110 enters the selected context, and is then provided with various scenarios (e.g., follow your friends into the bathroom, sit down on the couch, talk to a virtual characters 150, and the like) to select an action from within that context. The user 110 is prompted with a question such as, “Where would you like to go?” In one or more implementations, interactive video hotspots are embedded in the interactive video, which enable the user 110 to make a selection and then be taken to the specific user-selected scenario. In some implementations of the virtual experiential immersive learning platform 100, the lesson flow contains observational, experiential, and assessment components. Additionally, in some implementations, the lesson flow follows a specific learning progression in which the user 110 is required to observe more in scenarios toward the beginning of their learning experience, and then progress to interact and self-assess more in later stages of their learning experience.

In one or more implementations, the observational stage 250 of the virtual experiential immersive learning platform 100 is the main instructional component of the lesson experience. Correspondingly, the experiential stage 260 of the virtual experiential immersive learning platform 100 is where the user 110 is able to practice the skills they have learned in the observational stage 250. Additionally, the assessment stage 270 requires the users to self-assess by creating a video response to determine whether or not they implemented an adaptive response (i.e., made a responsible decision and creatively solved a problem). The assessment stage 270 also enables the user 110 to self-reflect using specific questions to understand the motives behind their choices and decisions they made as a response to the scenarios within the experiential stage 260 of the virtual experiential immersive learning platform 100.

In some implementations of the virtual experiential immersive learning platform 100, the user 110 views typical substance abuse situations and learns how an immersed individual is likely to “feel” and “think” within the observational stage 250 scenarios. The user 110 is also able to review the decisions he or she makes within the typical substance abuse situations and why those decisions were made. Additionally, the user 110 is able to study examples and non-examples of the adaptive response to the typical substance abuse situations. Furthermore, the user 110 is able to examine the resulting long-term and short-term consequences for the actions.

Notably, the observational stage 250 scenarios of the virtual experiential immersive learning platform 100 enable the user 110 to learn how immersed individuals (e.g., the user 110) may “feel” and “think” during substance abuse situations, how those thoughts and feelings relate to their decisions, and what the resulting consequences are of those feelings and resulting decisions. Additionally, the user 110 may also be able to better appreciate to what degree their decisions and actions are dependent on their thoughts and feelings (e.g., whether or not the user 110 is inclined to implement an adaptive response). The observational stage 250 scenarios of the virtual experiential immersive learning platform 100 also enable the user 110 to learn what the adaptive response entails and how the adaptive response works in a virtual experiential immersive learning environment.

In some implementations, during the experiential stage 260 of the virtual experiential immersive learning platform 100, the user 110 observes their selected scenario play out to a moment of decision. The user 110 is then prompted with a question, such as “What will you do?”, “How will you do it?”, and “Why?” The user 110 is prompted to and, in some implementations, required to provide their answer in a video response addressing all three of the above listed questions. After the user 110 has recorded his or her video, the user 110 is able to review his or her video and determine whether they would like to re-record the video self-assessment response.

In one or more implementations, at this point of the assessment stage 270, the user 110 is prompted to self-assess their video self-assessment response based on criteria provided by the virtual experiential immersive learning platform 100. These criteria provided by the virtual experiential immersive learning platform 100 highlight the key aspects of the adaptive response. During the assessment stage 270, the user 110 is prompted to reflect on their video by answering presented questions. Notably, the assessment stage 270 of the virtual experiential immersive learning platform 100 enables a user 110 to observe and evaluate whether they are implementing all the aspects of the adaptive response, as well as how they are implementing the adaptive response. Additionally, the assessment stage 270 of the virtual experiential immersive learning platform 100 enables a user 110 to gain self-awareness about their own motives, behaviors, and decisions related to substance abuse situations by experiencing these substance abuse situations in a virtual experiential immersive learning environment.

In some implementations of the virtual experiential immersive learning platform 100, a user 110 is asked the question at the assessment stage 270, “What action did you choose?” and is provided with options such as “I chose to engage in substance abuse,” “I chose not to engage in substance abuse,” and “other” (e.g., an open-ended response). If the user 110 indicates that they did not engage in substance abuse, they are provided with the following feedback and prompt: “Awesome! Great Choice! Please share with us your creative solution that accompanied your choice” (open-ended written response). After the user 110 submits their written creative solution to the virtual experiential immersive learning platform 100, the user 110 is asked, “Can we share your creative solution to help others?” If the user 110 opts in, then the user's 110 creative solution is shared publicly within the platform 110. Alternatively, the user 110 opts out, then the user's 110 creative solution is kept private.

If the user 110 indicates that they did choose to engage in substance abuse, then the user 110 is provided with supportive and instructive feedback (not judgmental “negative” feedback) within the virtual experiential immersive learning environment, such as by having a virtual characters 150 from within the lesson experience intervene on the users' behalf and model how to stand up for another. In some implementations of the virtual experiential immersive learning platform 100, the result of inappropriate decisions (e.g., to engage in substance abuse) includes the presentation to the user 110 of the immediate consequences and the long-term consequences of substance abuse. Additionally, in one or more implementations, key statistics related to substance abuse (e.g., death, disease, job loss, divorce, homelessness, and the like) are also presented. In this implementation in which the user 110 has made an inappropriate decision, after the virtual character 150 has intervened for the user 110, the user 110 is then provided with a selection of creative solutions that fit with the current scenario. The user 110 is then asked the question, “Could you have used any of these creative solutions instead of the choice you made?” In one or more implementations, if none of the creative solutions provided to the user 110 are selected as useful alternatives, and instead “none of the above” is selected, the user 110 is provided a recommendation to a highly reputable nationally recognized hotline.

In some implementations of the virtual experiential immersive learning platform 100, once both an adaptive and a non-adaptive interaction path are completed, the user 110 is prompted to identify their feelings and thoughts associated with the scenario and the choices that they made. For example, the user 110 may be asked, “What was the underlying feeling that influenced you to make this choice?” Correspondingly, a presentation of various feelings and emotions are provided as options to the user 110, including an open-ended option where the user 110 may indicate his or her own feelings (e.g., a feeling that may not be provided as an option). Additionally, the user 110 may be asked, “What were you thinking that contributed to how you were feeling?” Again, the user 110 is then presented with multiple-choice options representing various thinking patterns likely to be associated with adaptive and non-adaptive responses to the scenario, as well as an open-ended option to provide their individual thinking pattern.

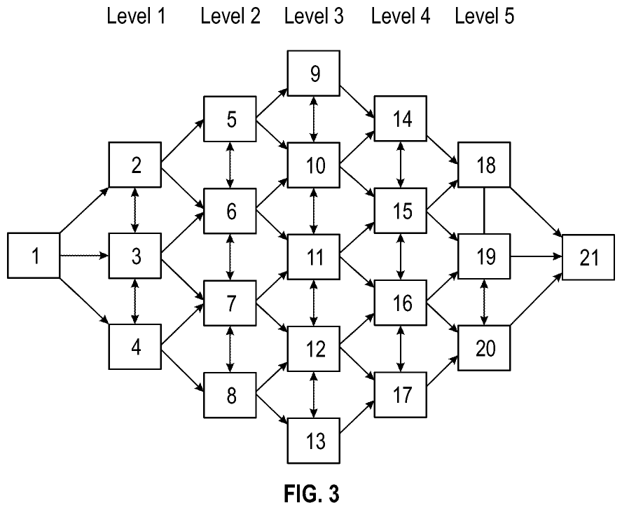

Referring now to FIG. 3, in various implementations of the virtual experiential immersive learning platform 100, many different lesson advancement configurations and types of lesson logic may be utilized. In one or more implementations, each lesson contains five levels (as shown in FIG. 2). In such an implementation, the first scenario at level one duplicates a pre-test scenario that targets medium complexity, and covers all the required lesson and learning objectives (See FIGS. 4-5) for the respective lesson. The subsequent scenarios in level one focus on character introductions and easier choices and decisions. Level two scenarios contain deeper character development and elevated temptation. Level three and four scenarios contain even more difficult choices and temptations. In the level five scenarios, the users must use their skills to intervene on a friend's behalf. The twenty-first scenario (after level five) is a duplicate scenario and is provided as a post-test scenario stage 280, after the assessment stage 270.

In at least one implementation, to advance to the next level of scenarios in the virtual experiential immersive learning platform 100, the user 110 makes an appropriate choice on each level. In one such implementation, the user has three attempts to make the appropriate choices. If after 3 three attempts the user 110 is still making inappropriate decisions, the user 110 is sent back to the beginning of the current level. Otherwise stated, the user 110 may not advance to the next level by making inappropriate choices. As mentioned above, when an inappropriate choice is made by the user 110, a programmed virtual character 150 intervenes and reroute the user 110 to a learning opportunity (e.g., short-term consequences, long-term consequences, statistics, and the like).

In some implementations, the observational stage 250 and the experiential stage 260/assessment stage 270 of each lesson will have twenty-one scenarios of the virtual experiential immersive learning platform 100. In other implementations, larger or smaller numbers of scenarios are present in each lesson. In still other implementations, larger or smaller numbers of lessons are present. In one or more implementations of the observational stage 250, each scenario is roughly six minutes (e.g., two minutes for the scene plus two minutes for the example plus two minutes for the non-example). In an implementation with five levels to each lesson, the quickest time period in which a user 110 may finish the observational stage 250 is thirty minutes. The longest time period in which a user 110 may finish the observational stage 250 is one hundred and twenty-six minutes. In some implementations, in the experiential stage 260 of the virtual experiential immersive learning platform 100, each scenario is roughly six minutes (two minutes for the scene, plus two minutes for user response, plus two minutes for the user self-assessment). In an implementation with five levels to each lesson, the quickest time period in which a user 110 may finish the experiential stage 260/assessment stage 270 is thirty minutes. The longest time period in which a user 110 may finish the experiential stage 260/assessment stage 270 is one hundred and twenty-six minutes.

Given the preceding time breakdown with one implementation of the virtual experiential immersive learning platform 100, the quickest a user 110 may finish an entire lesson, including the observational stage 250 and the experiential stage 260/assessment stage 270 components is one hour. Continuing in this implementation, the longest time period in which a user 110 may finish an entire lesson, if the user 110 watches every observational stage 250 scenario and completes every experiential stage 260/assessment stage 270 scenario, is four hours and ten minutes. The estimated median time to complete a lesson would be two and half hours, in one or more implementations that utilized this number and length of lessons and scenarios. Notably, in other implementations, larger or smaller time lengths of scenarios are includes in each lesson, which results in larger or smaller time lengths of lessons.

Referring now to FIGS. 4 and 5, lesson units, lesson objectives, and key learning objectives are presented that are taught to the user 110 in some implementations of the virtual experiential immersive learning platform 100. Specifically, the lessons units include: (1) How do our goal and motivational briefs influence our decisions, (2) What is substance use, and how do I know the difference between safe and unsafe usage, (3) What predisposes a person to addiction and substance abuse, including family history and dynamics, (4) How can I stand up for myself in threat situations, and (5) How can I stand up for others in threat situations.

With respect to the issue lesson unit (1), lesson objectives include: understanding and implementing goal setting; understanding self-efficacy, understanding self-worth, and understanding growth versus a fixed mindset. With respect to the issue lesson unit (2), lesson objectives include: understanding what substance abuse is and what it is not; differentiating various substances and their effects; and understanding when, how, and why it is safe/unsafe to use prescribed medications. With respect to the issue lesson unit (3), lesson objectives include: understanding the relationship between addiction predictors and substance abuse; and understanding the traits of an addictive personality. With respect to the issue lesson unit (4), lesson objectives include: understanding the nature and dynamics of substance abuse threat situations; and understanding the importance and how to stand up for oneself in substance abuse threat situations. With respect to the issue lesson unit (5), lesson objectives include: understanding the nature and dynamics of substance abuse threat situations; and understanding the importance and how to stand up for others in substance abuse threat situations.

With respect to the key learning objectives that are taught to the user 110 in some implementations of the virtual experiential immersive learning platform 100, these key learning objectives include: (1) understanding the physiological, emotional, and physical consequences of substance abuse, (2) have increased self-efficacy about intervening in substance abuse threat situations for one's self and others, (3) have increased growth mindset, (4) have increased self-worth, (5) have increased self and situational awareness about substance abuse threat situations, (6) exhibit increased assertiveness/resilience skills in substance abuse threat situations, and (7) implement adaptive responses to intervene on behalf of self and others in substance abuse threat situations.

While some implementations of the virtual experiential immersive learning platform 100 have been discussed with respect to virtual substance abuse scenarios, in other implementations, the virtual experiential immersive learning platform 100 is employed as an educational system and method for other virtual scenarios that represent other emotionally experiential environments, including by way of example only, and not by way of limitation: anti-bullying training scenarios, anti-discrimination training scenarios, anti-sexual harassment training scenarios, and anxiety-coping scenarios. The virtual experiential immersive learning platform 100 affords the user with a unique and authentic immersive educational experience, which by far exceeds traditional curriculum and approaches to teaching anti-bullying, anti-discrimination, anti-sexual harassment, and anxiety-coping.

The observational and experiential pedagogy of the virtual experiential immersive learning platform 100 enables users to observe and engage in immersive virtual interactions and practice creative solutions across occasions and contexts in virtual scenarios. The virtual experiential immersive learning platform 100 enables the user to practice adaptive tools, skills, strategies, and behaviors as part of the immersive educational experience, which increases the user's self-efficacy (i.e., belief about how successful they will be in the respective situations), and reduces the user's anxiety in each of these areas, thus, empowering the user to respond in confident, assertive, and positive behaviors.

Particularly with respect to anti-bullying, anti-discrimination, and anti-sexual harassment, the virtual experiential immersive learning platform 100 enables the user to observe and experience the various roles inherent in each scenario. In one implementation of the anti-bullying scenarios, users will have the opportunity to observe, interact, and practice skills and strategies within various bullying situations. As part of this interaction on the virtual experiential immersive learning platform 100, users are able to experience what it is like to be in the role of the individual being bullied, as well experience what it is like to be in the role of the bully. This approach to instruction that is enabled by the virtual experiential immersive learning platform 100 is unique in that it not only affords the user with ample opportunities for practice, but also develops situational understanding from multiple perspectives and increases empathy. In this regard, the users develop an understanding of what it feels like to be a victim and what it feels like to be a perpetrator. Other types of educational tools simply do not generate the feelings and emotions that are experienced by users of the virtual experiential immersive learning platform 100.

Most traditional curriculum targeted at anti-bullying education focuses primarily on skill development and the perspective of the victim. In contrast, systems of methods of the virtual experiential immersive learning platform 100 enable the user to experience the roles of both victim and perpetrator, thereby developing empathy for both roles. Bullying is typically a learned behavior. Often the bully is a victim of previous bullying in another situation or relationship. Having this understanding of the current bully's past experiences helps encourage overall compassion, and a rehabilitation-focused, as opposed to punitive, approach to these types of situations.

In some implementations, the virtual experiential immersive learning platform 100 is employed as an educational system and method for other virtual anti-bullying training scenarios. In one such virtual anti-bullying training scenario, the user has to select an adaptive response not to engage in bullying activities in an immersive one-on-one situation. In another virtual anti-bullying training scenario, the user has to select an adaptive response not to engage in bullying activities in an immersive situation in which one or more other characters are bullying a target character, and the one or more other characters are encouraging the user to join in the bullying of the target character. In still another virtual anti-bullying training scenario, the user has to select an adaptive response to actively stop or prevent one or more other characters from engaging in bullying activities directed towards the target character in an immersive situation.

In other implementations, the virtual experiential immersive learning platform 100 is employed as an educational system and method for other virtual anti-discrimination training scenarios. In one such virtual anti-discrimination training scenario, the user has to select an adaptive response not to engage in discriminatory activities in an immersive one-on-one situation. In another virtual anti-discrimination training scenario, the user has to select an adaptive response not to engage in discriminatory activities in an immersive situation in which one or more other characters are engaged in discriminating activity towards a target character, and the one or more other characters are encouraging the user to join in the discriminating activity towards the target character. In still another virtual anti-discrimination training scenario, the user has to select an adaptive response to actively stop or prevent one or more other characters from engaging in discriminating activity towards the target character in an immersive situation.

In still other implementations, the virtual experiential immersive learning platform 100 is employed as an educational system and method for other virtual anti-sexual harassment training scenarios. In one such virtual anti-sexual harassment training scenario, the user has to select an adaptive response not to engage in sexual harassment activities in an immersive one-on-one situation. In another virtual anti-sexual harassment training scenario, the user has to select an adaptive response not to engage in sexual harassment activities in an immersive situation in which one or more other characters are engaged in sexual harassment activity towards a target character, and the one or more other characters are encouraging the user to join in the sexual harassment activity towards the target character. In still another virtual anti-sexual harassment training scenario, the user has to select an adaptive response to actively stop or prevent one or more other characters from engaging in sexual harassment activity towards the target character in an immersive situation.

In yet other implementations, the virtual experiential immersive learning platform 100 is employed as an educational system and method for other virtual anxiety-coping scenarios. In one such virtual anxiety-coping scenario, the user has to select an adaptive response to cope with anxiety in an immersive one-on-one situation with a virtual character. In another virtual anxiety-coping scenario, the user has to select an adaptive response to cope with anxiety in an immersive situation in which one or more other characters are engaged in anxiety inducing activity, and the one or more other characters are teasing the user regarding his or her anxiety, or otherwise are intentionally making the virtual scenario more difficult for the user. In still another virtual anxiety-coping scenario, the user has to select an adaptive response to help another character that is experiencing anxiety or actively stop one or more other characters from engaging in anxiety inducing activity towards a target character in an immersive situation.

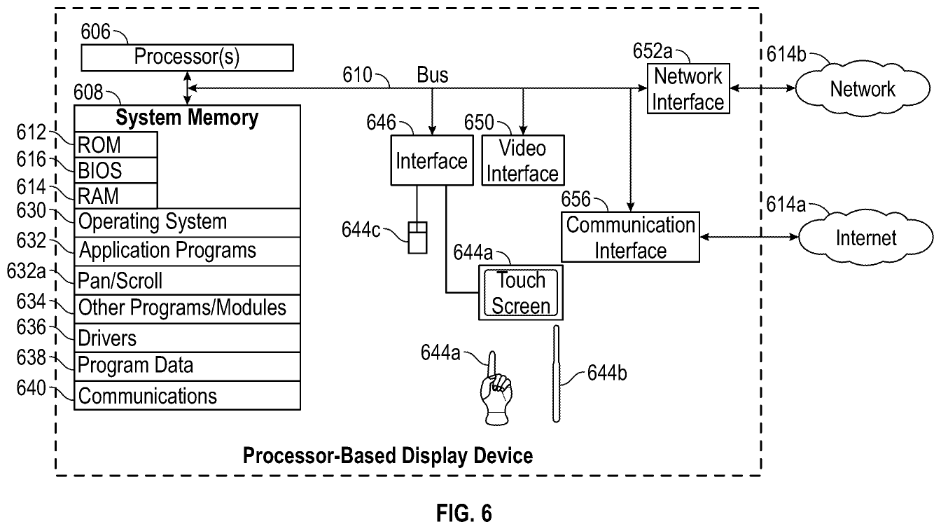

FIG. 6 shows a processor-based device suitable for implementing the mobile processor-based display device 120, which are described above with respect to a system for virtual experiential immersive learning platform 100. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

In the system for virtual experiential immersive learning platform 100, the processor-based device may, for example, take the form of a smartphone or wearable smart glasses, which includes one or more processors 606, a system memory 608 and a system bus 610 that couples various system components including the system memory 608 to the processor(s) 606. The processor-based device will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, and 68xxx series microprocessors from Motorola Corporation.

The processor(s) 606 in the processor-based devices of the system for virtual experiential immersive learning platform 100 may be any logic processing unit, such as one or more central processing units (CPUs), microprocessors, digital signal processors (DSPs), application-specific integrated circuits (ASICs), field programmable gate arrays (FPGAs), and the like. Unless described otherwise, the construction and operation of the various blocks shown in FIG. 6 are of conventional design. As a result, such blocks need not be described in further detail herein, as they will be understood by those skilled in the relevant art.

The system bus 610 in the processor-based devices of the system for virtual experiential immersive learning platform 100 can employ any known bus structures or architectures, including a memory bus with memory controller, a peripheral bus, and a local bus. The system memory 608 includes read-only memory (“ROM”) 612 and random access memory (“RAM”) 614. A basic input/output system (“BIOS”) 616, which can form part of the ROM 612, contains basic routines that help transfer information between elements within a processor-based device, such as during start-up. Some implementations may employ separate buses for data, instructions and power.

The processor-based device of the system for virtual experiential immersive learning platform 100 may also include one or more solid-state memories; for instance, a Flash memory or solid-state drive (SSD), which provides nonvolatile storage of computer-readable instructions, data structures, program modules and other data for the processor-based device. Although not depicted, the processor-based device can employ other nontransitory computer- or processor-readable media, for example, a hard disk drive, an optical disk drive, or a memory card media drive.

Program modules in the processor-based devices of the system for virtual experiential immersive learning platform 100 can be stored in the system memory 608, such as an operating system 630, one or more application programs 632, other programs or modules 634, drivers 636 and program data 638.

The application programs 632 may, for example, include panning/scrolling 632a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 632a may, for example, be stored as one or more executable instructions. The panning/scrolling logic 632a may include processor and/or machine executable logic or instructions to generate user interface objects using data that characterizes movement of a pointer, for example, data from a touch-sensitive display or from a computer mouse or trackball, or other user interface device.

The system memory 608 in the processor-based devices of the system for virtual experiential immersive learning platform 100 may also include communications programs 640; for example, a server and/or a Web client or browser for permitting the processor-based device to access and exchange data with other systems such as user computing systems, Web sites on the Internet, corporate intranets, or other networks as described below. The communications program 640 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 6 as being stored in the system memory 608, operating system 630, application programs 632, other programs/modules 634, drivers 636, program data 638 and server and/or browser can be stored on any other of a large variety of nontransitory processor-readable media (e.g., hard disk drive, optical disk drive, SSD and/or flash memory).

A user of a processor-based device in the system for virtual experiential immersive learning platform 100 can enter commands and information via a pointer; for example, through input devices such as a touch screen 648 via a finger 644a, stylus 644b, or via a computer mouse or trackball 644c which controls a cursor. Other input devices can include a microphone, joystick, game pad, tablet, scanner, biometric scanning device, and the like. These and other input devices (i.e., “I/O devices”) are connected to the processor(s) 606 through an interface 646 such as a touch-screen controller and/or a universal serial bus (“USB”) interface that couples user input to the system bus 610, although other interfaces such as a parallel port, a game port or a wireless interface or a serial port may be used. The touch screen 648 can be coupled to the system bus 610 via a video interface 650, such as a video adapter to receive image data or image information for display via the touch screen 648. Although not shown, the processor-based device can include other output devices, such as speakers, vibrator, haptic actuator or haptic engine, and the like.

The processor-based devices of the system for virtual experiential immersive learning platform 100 operate in a networked environment using one or more of the logical connections to communicate with one or more remote computers, servers and/or devices via one or more communications channels, for example, one or more networks 614a, 614b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based devices of the system for virtual experiential immersive learning platform 100 may include one or more network, wired or wireless communications interfaces 652a, 656 (e.g., network interface controllers, cellular radios, WI-FI radios, Bluetooth radios) for establishing communications over the network, for instance, the Internet 614a or cellular network 614b.

In a networked environment, program modules, application programs, or data, or portions thereof, can be stored in a server computing system (not shown). Those skilled in the relevant art will recognize that the network connections shown in FIG. 6 are only some examples of ways of establishing communications between computers, and other connections may be used, including wirelessly.

For convenience, the processor(s) 606, system memory 608, and network and communications interfaces 652a, 656 are illustrated as communicably coupled to each other via the system bus 610, thereby providing connectivity between the above-described components. In alternative implementations of the processor-based device, the above-described components may be communicably coupled in a different manner than illustrated in FIG. 6. For example, one or more of the above-described components may be directly coupled to other components, or may be coupled to each other, via intermediary components (not shown). In some implementations, system bus 610 is omitted and the components are coupled directly to each other using suitable connections.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), one or more communicative link(s) through one or more wireless communication protocol(s), and/or optical pathways (e.g., optical fiber), and exemplary communicative couplings include, but are not limited to, electrical couplings, magnetic couplings, wireless couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other portable and/or wearable electronic devices, not necessarily the exemplary wearable electronic devices generally described above.

For instance, the foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A system for providing a processor-based, virtual experiential immersive learning platform where a user observes and interacts with various substance abuse scenarios and resulting consequences from user decisions, the system comprising:
at least one processor-based server containing immersive 360-degree video content that includes interactive video hotspots with virtual substance abuse scenarios, wherein the interactive video hotspots enable the user to interact with discrete locations in the virtual substance abuse scenarios to link to additional interactive content, wherein the interactive video hotspots enable the user to proceed through the immersive 360-degree video content in a non-linear self-directed course and provide responses to decision points in the virtual substance abuse scenarios;
at least one processor-based interactive display device in communication with the at least one processor-based server, wherein the at least one processor-based interactive display device includes at least one processor and at least one processor-readable medium communicatively coupled to the at least one processor and which stores processor-executable instructions that, when executed by the at least one processor, cause the at least one processor to:
enable the user to interact with the processor-based, virtual experiential immersive learning platform in an observational stage within the virtual substance abuse scenarios, wherein the user observes typical scenarios and responses in the observational stage within the virtual substance abuse scenarios;
enable the user to interact with the processor-based, virtual experiential immersive learning platform in an experiential stage within the virtual substance abuse scenarios, wherein the user is prompted to interact with the virtual substance abuse scenarios, make choices within the virtual substance abuse scenarios, and provide responses to decision points within the virtual substance abuse scenarios;
enable the user to interact with the processor-based, virtual experiential immersive learning platform in an assessment stage within the virtual substance abuse scenarios, wherein the user is prompted to record and upload self-assessment videos critiquing the responses of the user interacting with the virtual substance abuse scenarios in the experiential stage; and
enable the user to interact with other users within the processor-based, virtual experiential immersive learning platform within the virtual substance abuse scenarios, and learn from the other users through shared responses from the other users.

2. The system of claim 1, wherein the virtual experiential immersive learning platform enables the user to provide adaptive responses to decision points within the virtual substance abuse scenarios.

3. The system of claim 2, wherein an adaptive response includes user actions of think, feel, pause, breathe, say, and do, via the virtual experiential immersive learning platform.

4. The system of claim 1, wherein the virtual experiential immersive learning platform enables the user to provide non-adaptive responses to decision points within the virtual substance abuse scenarios.

5. The system of claim 1, wherein resulting consequences from user decisions to decision points in the substance abuse scenarios experienced on the virtual experiential immersive learning platform include statistics, short term consequences, and long term consequences.

6. The system of claim 1, wherein substance abuse lessons interacted with on the virtual experiential immersive learning platform include multiple scenarios per level, wherein the user determines an order in which the multiple scenarios per level are observed, experienced, and assessed, wherein all of the multiple scenarios per level must be successfully completed before the user may progress to a next level, wherein the substance abuse lessons include multiple levels per lesson, wherein the multiple levels have increasing levels of difficulty, and wherein the multiple levels must be completed in a fixed order from lower difficulty to highest difficulty.

7. The system of claim 1, wherein user responses to decision points within the virtual substance abuse scenarios on the virtual experiential immersive learning platform include helping the other users in the virtual substance abuse scenarios make positive choices and helping virtual characters in the virtual substance abuse scenarios make positive choices.

8. The system of claim 1, wherein the virtual experiential immersive learning platform enables the user to be assisted to make positive choices by the other users at decision points within the virtual substance abuse scenarios, and wherein the virtual experiential immersive learning platform enables the user to be assisted to make positive choices by the virtual characters at decision points within the virtual substance abuse scenarios.

9. The system of claim 1, wherein a substance abuse lesson provided on the virtual experiential immersive learning platform includes a pre-test scenario before the observational stage and a post-test scenario after the assessment stage.

10. The system of claim 1, wherein a substance abuse lesson provided on the virtual experiential immersive learning platform includes a celebrity introduction stage before the observational stage.

11. The system of claim 1, wherein a substance abuse lesson provided on the virtual experiential immersive learning platform includes team participation of multiple users in at least the experiential phase of the virtual substance abuse scenarios.

12. The system of claim 1, wherein the user within the virtual substance abuse scenarios on the virtual experiential immersive learning platform is assisted to make positive choices at decision points by virtual characters in some of the virtual substance abuse scenarios, and wherein the user within the virtual substance abuse scenarios on the virtual experiential immersive learning platform is tempted to make negative choices at decision points by the virtual characters in other of the virtual substance abuse scenarios.

13. The system of claim 1, wherein the user is prompted to select a specific scenario from a collection in an interactive lesson map, the specific scenarios including: a party at friend's house, a home environment, a work environment, a locker room environment, a dating scenario, a night club environment, a supportive friends scenario, and a bad-influence friends scenario.

14. The system of claim 13, wherein after the user enters the selected specific scenario, the user is then provided with various decision points from which to select an action from within that selected specific scenario, the various decision points including: follow your friends into the bathroom, sit down on the couch, talk to a virtual character, and go to the bar.

15. The system of claim 1, wherein the experiential phase of the virtual substance abuse scenarios on the virtual experiential immersive learning platform includes prompting the user to provide video response answers to questions that include “what do you do,” “how did you do it,” and “why did you do it.”

16. The system of claim 1, wherein the user is prompted to submit a creative solution to make a positive choice in a virtual substance abuse scenario, and wherein after the user submits the creative solution to make the positive choice in a virtual substance abuse scenario, the user is given a choice to opt in and share the creative solution with the other users or to opt out and not share the creative solution with other users.

17. The system of claim 1, wherein after the user has made a negative choice in a virtual substance abuse scenario, the user is provided with a selection of creative solutions that fit with the current scenario to assist in immersive experiential learning.

18. A method for providing a processor-based, virtual experiential immersive learning platform where a user observes and interacts with various substance abuse scenarios and resulting consequences from user decisions, the method comprising:
providing at least one processor-based server containing immersive 360-degree video content that includes interactive video hotspots with virtual substance abuse scenarios;
enabling, via the interactive video hotspots, the user to interact with discrete locations in the virtual substance abuse scenarios to link to additional interactive content;
enabling, via the interactive video hotspots, the user to proceed through the immersive 360-degree video content in a non-linear self-directed course and provide responses to decision points in the virtual substance abuse scenarios;
communicating, via a communication network, between at least one processor-based interactive display device and the at least one processor-based server, the at least one processor-based interactive display device including at least one processor and at least one processor-readable medium communicatively coupled to the at least one processor and which stores processor-executable instructions that, when executed by the at least one processor, cause the at least one processor to:
enable the user to interact with the processor-based, virtual experiential immersive learning platform in an observational stage within the virtual substance abuse scenarios, wherein the user observes typical scenarios and responses in the observational stage within the virtual substance abuse scenarios;
enable the user to interact with the processor-based, virtual experiential immersive learning platform in an experiential stage within the virtual substance abuse scenarios, wherein the user is prompted to interact with the virtual substance abuse scenarios, make choices within the virtual substance abuse scenarios, and provide responses to decision points within the virtual substance abuse scenarios; and
enable the user to interact with the processor-based, virtual experiential immersive learning platform in an assessment stage within the virtual substance abuse scenarios, wherein the user is prompted to record and upload self-assessment videos critiquing the responses of the user interacting with the virtual substance abuse scenarios in the experiential stage.

19. The method of claim 18, wherein the virtual experiential immersive learning platform enables the user to provide adaptive responses to decision points within the virtual substance abuse scenarios.

20. The method of claim 19, wherein an adaptive response includes user actions of think, feel, pause, breathe, say, and do, via the virtual experiential immersive learning platform.

21. The method of claim 18, wherein the virtual experiential immersive learning platform enables the user to provide non-adaptive responses to decision points within the virtual substance abuse scenarios.

22. The method of claim 18, wherein resulting consequences from user decisions to decision points in the substance abuse scenarios experienced on the virtual experiential immersive learning platform include statistics, short term consequences, and long term consequences.

23. The method of claim 18, wherein substance abuse lessons experienced on the virtual experiential immersive learning platform include multiple scenarios per level, wherein the user determines an order in which the multiple scenarios per level are observed, experienced, and assessed, wherein all of the multiple scenarios per level must be successfully completed before the user may progress to a next level, wherein the substance abuse lessons include multiple levels per lesson, wherein the multiple levels have increasing levels of difficulty, and wherein the multiple levels must be completed in a fixed order from lower difficulty to highest difficulty.

24. The method of claim 18, wherein user responses to decision points within the virtual substance abuse scenarios on the virtual experiential immersive learning platform include helping the other users in the virtual substance abuse scenarios make positive choices and helping virtual characters in the virtual substance abuse scenarios make positive choices.

25. The method of claim 18, wherein the virtual experiential immersive learning platform enables the user to be assisted to make positive choices by the other users at decision points within the virtual substance abuse scenarios, and wherein the virtual experiential immersive learning platform enables the user to be assisted to make positive choices by the virtual characters at decision points within the virtual substance abuse scenarios.

26. The method of claim 18, wherein a substance abuse lesson provided on the virtual experiential immersive learning platform includes a pre-test scenario before the observational stage and a post-test scenario after the assessment stage.

27. The method of claim 18, wherein a substance abuse lesson provided on the virtual experiential immersive learning platform includes a celebrity introduction stage before the observational stage.

28. The method of claim 18, wherein a substance abuse lesson provided on the virtual experiential immersive learning platform includes team participation of multiple users in at least the experiential phase of the virtual substance abuse scenarios.

29. The method of claim 18, wherein the user within the virtual substance abuse scenarios on the virtual experiential immersive learning platform is assisted to make positive choices at decision points by the virtual characters in some of the virtual substance abuse scenarios, and wherein the user within the virtual substance abuse scenarios on the virtual experiential immersive learning platform is tempted to make negative choices at decision points by the virtual characters in other of the virtual substance abuse scenarios.

30. The method of claim 18, wherein the user is prompted to select a specific scenario from a collection in an interactive lesson map, the specific scenarios including: a party at friend's house, a home environment, a work environment, a locker room environment, a dating scenario, a night club environment, a supportive friends scenario, and a bad-influence friends scenario.

31. The method of claim 30, wherein after the user enters the selected specific scenario, the user is then provided with various decision points from which to select an action from within that selected specific scenario, the various decision points including: follow your friends into the bathroom, sit down on the couch, talk to a virtual character, and go to the bar.

32. The method of claim 18, wherein the experiential phase of the virtual substance abuse scenarios on the virtual experiential immersive learning platform includes prompting the user to provide video response answers to the questions, “what do you do,” “how did you do it,” and “why did you do it.”

33. The method of claim 1, wherein the user is prompted to submit a creative solution to make a positive choice in a virtual substance abuse scenario, and wherein after the user submits the creative solution to make the positive choice in a virtual substance abuse scenario, the user is given a choice to opt in and share the creative solution with the other users or to opt out and not share the creative solution with other users.

34. The method of claim 18, wherein after the user has made a negative choice in a virtual substance abuse scenario, the user is provided with a selection of creative solutions that fit with the current scenario to assist in immersive experiential learning.

35. A system for providing a processor-based, virtual experiential immersive learning platform where a user observes and interacts with various scenarios and resulting consequences from user decisions, the system comprising:
at least one processor-based server containing immersive 360-degree video content that includes interactive video hotspots with virtual scenarios, wherein the interactive video hotspots enable the user to interact with discrete locations in the virtual scenarios to link to additional interactive content, wherein the interactive video hotspots enable the user to proceed through the immersive 360 degree video content and provide responses to decision points in the virtual scenarios;
at least one processor-based interactive display device in communication with the at least one processor-based server, wherein the at least one processor-based interactive display device includes at least one processor and at least one processor-readable medium communicatively coupled to the at least one processor and which stores processor-executable instructions that, when executed by the at least one processor, cause the at least one processor to:
enable the user to interact with the processor-based, virtual experiential immersive learning platform in an observational stage within the virtual scenarios, wherein the user observes typical scenarios and responses in the observational stage within the virtual scenarios; and
enable the user to interact with the processor-based, virtual experiential immersive learning platform in an experiential stage within the virtual scenarios, wherein the user is prompted to interact with the virtual scenarios, make choices within the virtual scenarios, and provide responses to decision points within the virtual scenarios.
